(19) United States
(12) Patent Application Publication
(10) Pub. No.: US 2004/0030036 A1
(43) Pub. Date: Feb. 12, 2004

(54) Elastomeric composition

(76) Inventors: Walter H. Waddell, Pasadena, TX (US); Glenn E. Jones, Kingwood, TX (US); Ilan Duvdevani, Houston, TX (US)

Correspondence Address: ExxonMobil Chemical Company, Law Technology, PO Box 2149, Baytown, TX, 77522-2149, US

(21) Appl. No.: 10/398,303

(22) PCT Filed: Oct. 16, 2001
(86) PCT No.: PCT/US01/42766

(51) Int. Cl. C08K 3/00

(52) U.S. Cl. 524/567

(57) ABSTRACT

The present invention includes an elastomeric composition of a halogenated rubber component, a filler such as carbon black, and polybutene processing oil, the processing oil having a number average molecular weight of least 400 in one embodiment, and less than 10,000 in another embodiment. The rubber component can be a halogenated butyl rubber or a halogenated star-branched butyl rubber. In one embodiment, the polybutene processing oil is present in the composition from 2 to 30 phr, while the halogenated rubber component is present in the composition from 50 to 100 phr in one embodiment, and the filler is present from 10 to 150 phr in one embodiment. Further, a secondary rubber component may be present such as natural rubber. The compositions of the invention have an air permeability of from 1×10⁻⁸ to 3×10⁻⁸ cm³-cm/cm²-sec-atm at 65° C., and are useful for air barriers such as an innerliner for a tire.

### FIELD OF THE INVENTION

The present invention relates to compositions of halogenated butyl rubber and/or branched halogenated butyl rubber with polybutene processing oil, and more particularly to a halogenated butyl rubber component composition blended with polybutene processing oil to form an air barrier such as a tire innerliner.

### BACKGROUND OF THE INVENTION

Halobutyl rubbers (halogenated butyl rubber) are the polymers of choice for air-retention in tire innerliners for passenger, truck/bus, and aircraft applications. See, for example, U.S. Pat. Nos. 5,922,153, 5,491,196 and EP 0 102 844 and 0 127 998. Bromobutyl rubber, chlorobutyl rubbers, and branched (“star-branched”) halogenated butyl rubbers are isobutylene-based elastomers that can be formulated for these specific applications. The selection of ingredients for the final commercial formulation depends upon the balance of properties desired. Namely, processing properties of the green (precured) composition in the tire plant versus in-service performance of the cured tire composite are important, as is the nature of the tire, such as bias or radial, and its intended end use (e.g, aircraft, commercial or automobile). A continuing problem in the tire and innerliner industry is the ability to improve the processability of the innerliners without compromising a desirably low air permeability.

Resins and oils (or “processing aids”) such as naphthenic, paraffinic, and aliphatic resins may be used to improve the processability of elastomeric compounds. However, increased processability in the presence of oils and resins comes at the price of a loss of air impermeability, among other undesirable effects of various other properties.

Polybutene and paraffinic-type processing oils have been disclosed in U.S. Pat. No. 4,279,284 to Spadone, U.S. Pat. No. 5,964,969 to Sandstrom et al. and EP 0 314 416 to Mohammed. A paraffinic-type processing oil is disclosed in U.S. Pat. No. 5,631,316 to Costemalle et al. Also, WO 94/01295 to Gursky et al. discloses the use of petroleum waxes and naphthenic oils and resins in a rubber composition for tire sidewalls, and U.S. Ser. No. 09/691,764, filed Oct. 18, 2000 (assigned to the assignee of the present invention) to Waddell et al. discloses a colorable rubber compositions. Other disclosures of processing oil or resin-containing elastomeric or adhesive compositions include U.S. Pat. Nos. 5,005,625, 5,013,793, 5,162,409, 5,178,702, 5,234,987, 5,234,987, 5,242,727, 5,397,832, 5,733,621, 5,755,899, EP 0 682 071 A1, EP 0376 558B1, WO 92/16587, and JP11005874, JP05179068A and J03028244. None of these disclosures solves the problem of improving processability of elastomeric compositions useful for tires, air barriers, etc, while maintaining or improving the air impermeability of those compositions.

While the addition of naphthenic or paraffinic oils and resins improves some processing properties of rubber compositions, the air impermeability is adversely influenced. What is lacking in the art is an air barrier that has suitable processing properties and cure properties such as green strength, modulus, tensile strength, and hardness, while maintaining adequate air impermeability provided by halogenated butyl rubbers. The present invention solves this and other problems.

### SUMMARY OF THE INVENTION

The present invention includes an elastomeric composition of a halogenated rubber component, a filler such as carbon black, and polybutene processing oil having a number average molecular weight of at least 400 in one embodiment, and less than 10,000 in another embodiment. The rubber component can be a halogenated butyl rubber or a halogenated star-branched butyl rubber comprising a polydiene derived unit, a C₄ to C₆ isoolefin derived unit, and a conjugated diene derived unit. The polydiene is selected from polybutadiene, polyisoprene, polypiperylene, natural rubber, styrene-butadiene rubber, ethylene-propylene diene rubber, styrene-butadiene-styrene and styrene-isoprene-styrene block copolymers, and mixtures thereof.

Further, a secondary rubber component may be present, the secondary component selected from natural rubbers, polyisoprene rubber, styrene butadiene rubber, polybutadiene rubber, isoprene butadiene rubber, styrene isoprene butadiene rubber, ethylene-propylene rubber, and mixtures thereof. The compositions of the invention have an air permeability of from 1×10^{-b 8} to 3×10⁻⁸ cm³-cm/cm²-sec-atm at 65° C., and are useful for us as air barriers such as an innerliner for a tire. The compositions are suitable for use in any number of articles such as tire treads, tire sidewalls, hoses and belts, and air barriers such as innertubes and innerliners.

### DETAILED DESCRIPTION OF THE INVENTION

The term “phr” is parts per hundred rubber, and is a measure common in the art wherein components of a composition are measured relative to a major elastomer component, based upon 100 parts by weight of the elastomer or elastomers.

As used herein, in reference to Periodic Table “Groups”, the new numbering scheme for the Periodic Table Groups are used as in H AWLEY'S C ONDENSED C HEMICAL D ICTIONARY 852 (13th ed. 1997).

The term “elastomer”, as used herein, refers to any polymer or composition of polymers consistent with the ASTM D1566 definition. The term “elastomer” may be used interchangeably with the term “rubber”, as used herein.

Halogenated Rubber Component

The composition of the present invention is an elastomeric composition including a halogenated rubber component, and more particularly, a halogenated butyl rubber component, as a primary component. In one embodiment of the invention, the halogenated rubber component is a halogenated copolymer of a C₄ to C₆ isoolefin and a conjugated diene. In another embodiment, the halogenated rubber component is a composition of a polydiene or block copolymer, and a copolymer of a C₄ to C₆ isoolefin and a conjugated, or a “star-branched” butyl polymer.

In one embodiment, the halogenated butyl rubber is brominated butyl rubber, and in another embodiment is chlorinated butyl rubber. General properties and processing of halogenated butyl rubbers is described in T HE V ANDERBILT R UBBER H ANDBOOK 105-122 (Robert F. Ohm ed., R. T. Vanderbilt Co., Inc. 1990), and in R UBBER T ECHNOLOGY 311-321 (Maurice Morton ed., Chapman & Hall 1995). Butyl rubbers, halogenated butyl rubbers, and star-branched butyl rubbers are described by Edward Kresge and H. C Wang in 8 K IRK-O THMER E NCYCLOPEDIA OF C HEMICAL T ECHNOLOGY 934-955 (John Wiley & Sons, Inc. 4th ed. 1993).

The halogenated rubber component of the present invention includes, but is not limited to, brominated butyl rubber, chlorinated butyl rubber, star-branched polyisobutylene rubber, star-branched brominated butyl (polyisobutylene/isoprene copolymer) rubber; isobutylene-bromomethylstyrene copolymers such as isobutylene/meta-bromomethylstyrene, isobutylene/para-bromomethylstyrene, isobutylene/chloromethylstyrene, halogenated isobutylene cyclopentadiene, and isobutylene/para-chloromethylstyrene, and the like halomethylated aromatic interpolymers as in U.S. Pat. No. 4,074,035 and U.S. Pat. No. 4,395,506; halogenated isoprene and halogenated isobutylene copolymers, polychloroprene, and the like, and mixtures of any of the above. Some embodiments of the halogenated rubber component are also described in U.S. Pat. Nos. 4,703,091 and 4,632,963.

More particularly, in one embodiment of the brominated rubber component of the invention, a halogenated butyl rubber is used. The halogenated butyl rubber is produced from the halogenation of butyl rubber. Preferably, the olefin polymerization feeds employed in producing the halogenated butyl rubber of the invention are those olefinic compounds conventionally used in the preparation of butyl-type rubber polymers. In one embodiment, the butyl rubbers are prepared by reacting a comonomer mixture, the mixture having at least (1) a C₄ to C₆ isoolefin monomer component such as isobutylene with (2) a multiolefin, or conjugated diene, monomer component. The isoolefin is in a range from 70 to 99.5 wt % by weight of the total comonomer mixture in one embodiment, and 85 to 99.5 wt % in another embodiment. The conjugated diene component in one embodiment is present in the comonomer mixture from 30 to 0.5 wt % in one embodiment, and from 15 to 0.5 wt % in another embodiment. In yet another embodiment, from 8 to 0.5 wt % of the comonomer mixture is conjugated diene. In another embodiment, a homopolymer of either (1) or (2) is produced, which can then be halogenated.

The isoolefin is a C₄ to C₆ compound such as isobutylene, isobutene 2-methyl-1-butene, 3-methyl-1-butene, 2-methyl-2-butene, and 4-methyl-1-pentene. The multiolefin is a C₄ to C₁₄ conjugated diene such as isoprene, butadiene, 2,3-dimethyl-1,3-butadiene, myrcene, 6,6-dimethyl-fulvene, cyclopentadiene, hexadiene and piperylene. One embodiment of the butyl rubber polymer of the invention is obtained by reacting 92 to 99.5 wt % of isobutylene with 0.5 to 8 wt % isoprene, or reacting 95 to 99.5 wt % isobutylene with from 0.5 wt % to 5.0 wt % isoprene in yet another embodiment.

Halogenated butyl rubber is produced by the halogenation of the butyl rubber product described above. Halogenation can be carried out by any means, and the invention is not herein limited by the halogenation process. Methods of halogenating polymers such as butyl polymers are disclosed in U.S. Pat. Nos. 2,631,984, 3,099,644, 4,554,326, 4,681,921, 4,650,831, 4,384,072, 4,513,116 and 5,681,901. In one embodiment, the butyl rubber is halogenated in hexane diluent at from 4 to 60° C. using bromine (Br₂) or chlorine (Cl₂) as the halogenation agent. The halogenated butyl rubber has a Mooney Viscosity of from 20 to 70 (ML 1+8 at 125° C.) in one embodiment, and from 25 to 55 in another embodiment. The halogen wt % is from 0.1 to 10 wt % based in on the weight of the halogenated butyl rubber in one embodiment, and from 0.5 to 5 wt % in another embodiment. In yet another embodiment, the halogen wt % of the halogenated butyl rubber is from 1 to 2.5 wt %.

A commercial embodiment of the halogenated butyl rubber of the present invention is Bromobutyl 2222 (ExxonMobil Chemical Company). Its Mooney Viscosity is from 27 to 37 (ML 1+8 at 125° C., ASTM 1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D2084). Another commercial embodiment of the halogenated butyl rubber is Bromobutyl 2255 (ExxonMobil Chemical Company). Its Mooney Viscosity is from 41 to 51 (ML 1+8 at 125° C., ASTM D1646), and the bromine content is from 1.8 to 2.2 wt %. Further, cure characteristics of Bromobutyl 2255 are as follows: MH is from 34 to 48 dN·m. ML is from 11 to 21 dN·m (ASTM D2084).

In another embodiment of the brominated rubber component of the invention, a branched or “star-branched” halogenated butyl rubber is used. In one embodiment, the halogenated star-branched butyl rubber (“HSSB”) is a composition of a butyl rubber, either halogenated or not, and a polydiene or block copolymer, either halogenated or not. The halogenation process is described in detail in U.S. Pat. Nos. 4,074,035, 5,071,913, 5,286,804, 5,182,333 and 6,228,978. The invention is not limited by the method of forming the HSSB. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the HSSB. The branching agent or polydiene can be any suitable branching agent, and the invention is not limited to the type of polydiene used to make the HSSB.

In one embodiment, the HSSB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the HSSB of the present invention is Bromobutyl 6222 (ExxonMobil Chemical Company), having a Mooney Viscosity (ML 1+8 at 125° C., ASTM D1646) of from 27 to 37, and a bromine content of from 2.2 to 2.6 wt % relative to the HSSB. Further, cure characteristics of Bromobutyl 6222 are as follows: MH is from 24 to 38 dN·m, ML is from 6 to 16 dN·m (ASTM D2084).

The halogenated rubber component is present in the composition of the invention from 50 to 100 phr in one embodiment, from 70 to 100 phr in another embodiment, and from 85 to 100 in yet another embodiment.

Secondary Rubber Component

A secondary rubber component may also be present in the compositions of the invention. An embodiment of the secondary rubber component present is natural rubber. Natural rubbers are described in detail by Subramaniam in R UBBER T ECHNOLOGY 179-208 (1995). Desirable embodiments of the natural rubbers of the present invention are selected from Malaysian rubber such as SMR CV, SMR 5, SMR 10, SMR 20, and SMR 50 and mixtures thereof, wherein the natural rubbers have a Mooney Viscosity at 100° C. (ML 1+4) of from 30 to 120, more preferably from 40 to 65. The Mooney Viscosity test referred to herein is in accordance with ASTM D-1646.

Other secondary rubbers can also be used in the compositions of the invention. The secondary rubber component of the present composition compositions are selected from natural rubbers, polyisoprene rubber, styrene butadiene rubber (SBR), polybutadiene rubber, isoprene butadiene rubber (IBR), styrene-isoprene-butadiene rubber (SIBR), ethylene-propylene rubber, ethylene-propylene-diene rubber (EPDM) and mixtures thereof. When present, the secondary rubber component of the elastomer composition may be present in a range from 1 to 50 phr in one embodiment, from 2 to 40 phr in another embodiment, and from 3 to 30 phr in yet another embodiment.

Some commercial examples of synthetic secondary rubbers useful in the present invention are NATSYN™ (Goodyear Chemical Company), and BUDENE™ 1207 or BR 1207 (Goodyear Chemical Company). A desirable rubber is high cis-polybutadiene (cis-BR). By “cis-polybutadiene” or “high cis-polybutadiene”, it is meant that 1,4-cis polybutadiene is used, wherein the amount of cis component is at least 95%. An example of high cis-polybutadiene commercial products used in the composition BUDENE™ 1207. A suitable ethylene-propylene rubber is commercially available as VISTALON™ (ExxonMobil Chemical Company).

In one embodiment of the invention, a so called semi-crystalline copolymer (SCC) is present as the secondary rubber. Semi-crystalline copolymers are described in U.S. Ser. No. 09/569,363, filed on May 11, 2000 (assigned to the assignee of the present invention). Generally, the SCC is a copolymer of ethylene or propylene derived units and α-olefin derived units, the α-olefin having from 4 to 16 carbon atoms in one embodiment, and in another embodiment the SCC is a copolymer of ethylene derived units and α-olefin derived units, the α-olefin having from 4 to 10 carbon atoms, wherein the SCC has some degree of crystallinity. In a further embodiment, the SCC is a copolymer of 1-butene derived units and another α-olefin derived unit, the other α-olefin having from 5 to 16 carbon atoms, wherein the SCC also has some degree of crystallinity. The SCC can also be a copolymer of ethylene and styrene.

The preferred semicrystalline polymer is a thermoplastic copolymer, preferably random, of ethylene and propylene having a melting point by Differential Scanning Calorimetry (DSC) analysis of from about 25° C. to about 105° C., preferably in the range of from about 25° C. to about 90° C., more preferably in the range of from about 35° C. to about 80° C. and an average propylene content by weight of from at least about 75% and more preferably from at least about 80%, and most preferably from at least about 90%. The semi-crystalline polymer preferably has a heat of fusion from about 9 J/g to about 50 J/g as determined by DSC, more preferably from about 11 J/g to about 38 J/g as determined by DSC, and most preferably from about 15 J/g to about 25 J/g as determined by DSC.

The preferred procedure used in the present application for DSC is described as follows. Preferably, about 6 mg to about 10 mg of a sheet of the preferred polymer pressed at approximately 200° C. to 230° C. is removed with a punch die and is annealed at room temperature for 240 hours. At the end of this period, the sample is placed in a Differential Scanning Calorimeter (Perkin Elmer 7 Series Thermal Analysis System) and cooled to about −50° C. to −70° C. The sample is heated at about 20° C./min to attain a final temperature of about 200° C. to about 220° C. The thermal output is recorded as the area under the melting peak of the sample which is typically at a maximum peak at about 30° C. to about 175° C. and occurs between the temperatures of about 0° C. and about 200° C. The thermal output is measured in Joules as a measure of the heat of fusion. The melting point is recorded as the temperature of the greatest heat absorption within the range of melting temperature of the sample.

The semi-crystalline polymer of the composition in the present invention comprises a crystallizable copolymer of propylene and another alpha-olefin having less than 10 carbon atoms, preferably ethylene. The crystallinity of the SCC arises from crystallizable stereoregular propylene sequences. The SCP of the present invention preferably comprises a random crystallizable copolymer having a narrow compositional distribution. The term “crystallizable,” as used herein for SCC, describes those polymers or sequences which are mainly amorphous in the undeformed state, but can crystallize upon stretching, annealing or in the presence of a crystalline polymer.

Filler

The elastomeric composition may have one or more filler components such as calcium carbonate, clay, mica, silica and silicates, talc, titanium dioxide, and carbon black. In one embodiment, the filler is carbon black or modified carbon black. The preferred filler is semi-reinforcing grade carbon black present at a level of from 10 to 150 phr of the composition, more preferably from 30 to 120 phr. Useful grades of carbon black as described in R UBBER T ECHNOLOGY 59-85 (1995) range from N 110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N351, N550, N650, N660, and N762. Embodiments of the carbon black useful in, for example, innerliners for tires are N550, N650, N660, N762, and N990.

Polybutene Processing Oil

Polybutene processing oil is present in the composition of the invention. In one embodiment of the invention, the polybutene processing oil is a low molecular weight (less than 15,000 Mn) homopolymer or copolymer of olefin derived units having from 3 to 8 carbon atoms in one embodiment, preferably from 4 to 6 carbon atoms in another embodiment. In yet another embodiment, the polybutene is a homopolymer or copolymer of a C₄ raffinate. An embodiment of such low molecular weight polymers termed “polybutene” polymers is described in, for example, S YNTHETIC LUBRICANTS AND H IGH-P ERFORMANCE F UNCTIONAL F LUIDS 357-392 (Leslie R. Rudnick & Ronald L. Shubkin, ed., Marcel Dekker 1999) (hereinafter “polybutene processing oil” or “polybutene”).

In one embodiment of the invention, the polybutene processing oil is a copolymer of at least isobutylene derived units, 1-butene derived units, and 2-butene derived units. In one embodiment, the polybutene is a homopolymer, copolymer, or terpolymer of the three units, wherein the isobutylene derived units are from 40 to 100 wt % of the copolymer, the 1-butene derived units are from 0 to 40 wt % of the copolymer, and the 2-butene derived units are from 0 to 40 wt % of the copolymer. In another embodiment, the polybutene is a copolymer or terpolymer of the three units, wherein the isobutylene derived units are from 40 to 99 wt % of the copolymer, the 1-butene derived units are from 2 to 40 wt % of the copolymer, and the 2-butene derived units are from 0 to 30 wt % of the copolymer. In yet another embodiment, the polybutene is a terpolymer of the three units, wherein the isobutylene derived units are from 40 to 96 wt % of the copolymer, the 1-butene derived units are from 2 to 40 wt % of the copolymer, and the 2-butene derived units are from 2 to 20 wt % of the copolymer. In yet another embodiment, the polybutene is a homopolymer or copolymer of isobutylene and 1-butene, wherein the isobutylene derived units are from 65 to 100 wt % of the homopolymer or copolymer, and the 1-butene derived units are from 0 to 35 wt % of the copolymer.

Polybutene processing oils useful in the invention typically have a number average molecular weight (Mn) of less than 10,000 in one embodiment, less than 8000 in another embodiment, and less than 6000 in yet another embodiment. In one embodiment, the polybutene oil has a number average molecular weight of greater than 400, and greater than 700 in another embodiment, and greater than 900 in yet another embodiment. A preferred embodiment can be a combination of any lower limit with any upper limit herein. For example, in one embodiment of the polybutene of the invention, the polybutene has a number average molecular weight of from 400 to 10,000, and from 700 to 8000 in another embodiment. Useful viscosities of the polybutene processing oil ranges from 10 to 6000 cSt (centiStokes) at 100° C. in one embodiment, and from 35 to 5000 cSt at 100° C. in another embodiment, and is greater than 35 cSt at 100° C. in yet another embodiment, and greater than 100 cSt at 100° C. in yet another embodiment.

Commercial examples of such a processing oil are the PARAPOL™ Series of processing oils (ExxonMobil Chemical Company, Houston Tex.), such as PARAPOL™ 450, 700, 950, 1300, 2400 and 2500. The commercially available PARAPOL™ Series of polybutene processing oils are synthetic liquid polybutenes, each individual formulation having a certain molecular weight, all formulations of which can be used in the composition of the invention. The molecular weights of the PARAPOL™ oils are from 420 Mn (PARAPOL™ 450) to 2700 Mn (PARAPOL™ 2500) as determined by gel permeation chromatography. The MWD (Mw/Mn) of the PARAPOL™ oils range from 1.8 to 3 in one embodiment, and from 2 to 2.8 in another embodiment.

Below, Table 1 shows some of the properties of the PARAPOL™ oils useful in embodiments of the present invention, wherein the viscosity was determined as per ASTM D445-97, and the molecular weight by gel permeation chromatography.

TABLE 1
Properties of individual PARAPOL ™ Grades

| | | Viscosity @ |
|---|---|---|
| Grade | Mn | 100° C., cSt |
| 450 | 420 | 10.6 |
| 700 | 700 | 78 |
| 950 | 950 | 230 |
| 1300 | 1300 | 630 |
| 2400 | 2350 | 3200 |
| 2500 | 2700 | 4400 |

Other properties of PARAPOL™ processing oils are as follows: the density (g/mL) of PARAPOL™ processing oils varies from about 0.85 (PARAPOL™ 450) to 0.91 (PARAPOL™ 2500). The bromine number (CG/G) for PARAPOL™ oils ranges from 40 for the 450 Mn processing oil, to 8 for the 2700 Mn processing oil.

The elastomeric composition of the invention may include one or more types of polybutene as a mixture, blended either prior to addition to the elastomer, or with the elastomer. The amount and identity (e.g., viscosity, Mn, etc.) of the polybutene processing oil mixture can be varied in this manner. Thus, PARAPOL™ 450 can be used when low viscosity is desired in the composition of the invention, while PARAPOL™ 2500 can be used when a higher viscosity is desired, or compositions thereof to achieve some other viscosity or molecular weight. In this manner, the physical properties of the composition can be controlled. More particularly, the phrases “a polybutene processing oil”, or “polybutene processing oil” include a single oil or a composition of two or more oils used to obtain any viscosity or molecular weight (or other property) desired, as specified in the ranges disclosed herein.

The polybutene processing oil or oils are present in the elastomeric composition of the invention from 1 to 60 phr in one embodiment, and from 2-40 phr in another embodiment, from 4-35 phr in another embodiment, and from 5-30 phr in yet another embodiment. Preferably, the polybutene processing oil does not contain aromatic groups or unsaturation.

Curing Agents and Accelerators

The compositions produced in accordance with the present invention typically contain other components and additives customarily used in rubber mixes, such as pigments, accelerators, cross-linking and curing materials, antioxidants, antiozonants, and fillers. In one embodiment, processing aids (resins) such as naphthenic, aromatic or paraffinic extender oils may be present from 1 to 30 phr. In another embodiment, naphthenic, aliphatic, paraffinic and other aromatic resins and oils are substantially absent from the composition. By “substantially absent”, it is meant that naphthenic, aliphatic, paraffinic and other aromatic resins are present, if at all, to an extent no greater than 2 phr in the composition.

Generally, polymer compositions, e.g., those used to produce tires, are crosslinked. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR, R UBBER W ORLD 18-23 (1991). Cross-linking and curing agents include sulfur, zinc oxide, and fatty acids. Peroxide cure systems may also be used. Generally, polymer compositions may be crosslinked by adding curative molecules, for example sulfur, metal oxides (i.e., zinc oxide), organometallic compounds, radical initiators, etc. followed by heating. In particular, the following are common curatives that will function in the present invention: ZnO, CaO, MgO, Al₂O₃, CrO₃, FeO, Fe₂O₃, and NiO. These metal oxides can be used in conjunction with the corresponding metal stearate complex (e.g., Zn(Stearate)₂, Ca(Stearate)₂, Mg(Stearate)₂, and Al(Stearate)₃), or with stearic acid, and either a sulfur compound or an alkylperoxide compound. (See also, Formulation Design and Curing Characteristics of NBR Mixes for Seals, R UBBER W ORLD 25-30 (1993). This method may be accelerated and is often used for the vulcanization of elastomer compositions. Cure systems for brominated butyl rubber are described in R UBBER T ECHNOLOGY 312-316 (1995), and in U.S. Pat. No. 5,373,062.

Accelerators include amines, guanidines, thioureas, thiazoles, thiurams, sulfenamides, sulfenimides, thiocarbamates, xanthates, and the like. Acceleration of the cure process may be accomplished by adding to the composition an amount of an accelerant. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS) zinc 2-ethyl hexanoate (ZEH), N,N′-diethyl thiourea.

In one embodiment of the invention, at least one curing agent is present from 0.2 to 15 phr, and from 0.5 to 10 phr in another embodiment. Curing agents include those components described above that facilitate or influence the cure of elastomers, such as metals, accelerators, sulfur, peroxides, and other agents common in the art and as described above.

Processing

The materials are mixed by conventional means known to those skilled in the art, in a single step or in stages. In one embodiment, the carbon black is added in a different stage from zinc oxide and other cure activators and accelerators. In another embodiment, antioxidants, antiozonants and processing materials are added in a stage after the carbon black has been processed with the elastomeric composition, and zinc oxide is added at a final stage to maximize compound modulus. Thus, a two to three (or more) stage processing sequence is preferred. Additional stages may involve incremental additions of filler and processing oils.

The compositions may be vulcanized by subjecting them using heat or radiation according to any conventional vulcanization process. Typically, the vulcanization is conducted at a temperature ranging from about 100° C. to about 250° C. in one embodiment, from 150° C. to 200° C. in another embodiment, for about 1 to 150 minutes.

Suitable elastomeric compositions for such articles as tire innerliners may be prepared by using conventional mixing techniques including, e.g., kneading, roller milling, extruder mixing, internal mixing (such as with a Banbury™ or Brabender™ mixer) etc. The sequence of mixing and temperatures employed are well known to the skilled rubber compounder, the objective being the dispersion of fillers, activators and curatives in the polymer matrix without excessive heat buildup. A useful mixing procedure utilizes a Banbury™ mixer in which the copolymer rubber, carbon black and plasticizer are added and the composition mixed for the desired time or to a particular temperature to achieve adequate dispersion of the ingredients. Alternatively, the rubber and a portion of the carbon black (e.g., one-third to two thirds) is mixed for a short time (e.g., about 1 to 3 minutes) followed by the remainder of the carbon black and oil. Mixing is continued for about 5 to 10 minutes at high rotor speed during which time the mixed components reach a temperature of about 140° C. Following cooling, the components are mixed in a second step on a rubber mill or in a Banbury™ mixer during which the curing agent and optional accelerators, are thoroughly and uniformly dispersed at relatively low temperature, e.g., about 80° C. to about 105° C., to avoid premature curing of the composition. Variations in mixing will be readily apparent to those skilled in the art and the present invention is not limited to any specific mixing procedure. The mixing is performed to disperse all components of the composition thoroughly and uniformly.

An innerliner stock is then prepared by calendering the compounded rubber composition into sheet material having a thickness of roughly 40 to 80 mil gauge and cutting the sheet material into strips of appropriate width and length for innerliner applications.

The sheet stock at this stage of the manufacturing process is a sticky, uncured mass and is therefore subject to deformation and tearing as a consequence of handling and cutting operations associated with tire construction.

The innerliner is then ready for use as an element in the construction of a pneumatic tire. The pneumatic tire is composed of a layered laminate comprising an outer surface which includes the tread and sidewall elements, an intermediate carcass layer which comprises a number of plies containing tire reinforcing fibers, (e.g., rayon, polyester, nylon or metal fibers) embedded in a rubbery matrix and an innerliner layer which is laminated to the inner surface of the carcass layer. Tires are normally built on a tire forming drum using the layers described above. After the uncured tire has been built on the drum, the uncured tire is placed in a heated mold having an inflatable tire shaping bladder to shape it and heat it to vulcanization temperatures by methods well known in the art. Vulcanization temperatures generally range from about 100° C. to about 250° C., more preferably from 150° C. to 200° C., and times may range from about one minute to several hours, more preferably from about 5 to 30 minutes. Vulcanization of the assembled tire results in vulcanization of all elements of the tire assembly, i.e., the innerliner, the carcass and the outer tread/sidewall layers and enhances the adhesion between these elements, resulting in a cured, unitary tire from the multi-layers.

One desirable embodiment of the composition includes from 70 to 90 phr of brominated butyl rubber, such as Bromobutyl 2222 (ExxonMobil Chemical Company, Houston Tex.) is present with from 10 to 30 phr of natural rubber and from 40 to 70 phr of carbon black, such as N-660 carbon black, and from 4 to 10 phr of polybutene oil such as PARAPOL™ 1300 or 2500. From 0.05 to 5 phr of other cure agents and accelerators may also be present. This embodiment may also include from 1 to 10 phr of a naphthenic resin in one embodiment, and be substantially free of naphthenic resins (from 0 to 2 phr) in another embodiment.

Another desirable embodiment of the composition of the invention includes from 80 to 100 phr of brominated star-branched butyl rubber, such as Bromobutyl-6222 (ExxonMobil Chemical Company, Houston Tex.), and from 0 to 20 phr of a secondary rubber such as natural rubber present with from 40 to 70 phr carbon black, and from 4 to 10 phr of polybutene oil such as PARAPOL™ 1300 or 2500. From 0.05 to 5 phr of other cure agents and accelerators may also be present. This embodiment may also include from 1 to 10 phr of a naphthenic resin in one embodiment, and be substantially free of naphthenic resins (from 0 to 2 phr) in another embodiment.

Yet another desirable embodiment of the composition of the invention includes from 70 to 100 phr of brominated star-branched butyl rubber, such as Bromobutyl-6222 (ExxonMobil Chemical Company, Houston Tex.), and from 5 to 30 phr of semi-crystalline copolymers (SCC) present with from 40 to 70 phr carbon black, and from 4 to 10 phr of polybutene oil such as PARAPOL™ 1300 or 2500. From 0.05 to 5 phr of other cure agents and accelerators may also be present. This embodiment may also include from 1 to 10 phr of a naphthenic resin in one embodiment, and be substantially free of naphthenic resins (from 0 to 2 phr) in another embodiment.

The air barrier composition of the present invention may be used in producing innerliners for motor vehicle tires such as truck tires, bus tires, passenger automobile tires, motorcycle tires, off the road tires, and the like.

Test Methods

Cure properties were measured using a ODR 2000 at the indicated temperature and 3 degree arc. Test specimens were cured at the indicated temperature, typically from 150° C. to 160° C., for a time corresponding to T90+appropriate mold lag. When possible, standard ASTM tests were used to determine the cured compound physical properties. Stress/strain properties (tensile strength, elongation at break, modulus values, energy to break) were measured at room temperature using an Instron 4202. Shore A hardness was measured at room temperature by using a Zwick Duromatic. The error (2σ) in measuring 100% Modulus is ±0.11 MPa units; the error (2σ) in measuring elongation is ±13% units.

The values of Tg were determined using the DMTA (Dynamic Mechanical Tensile Analyzer) test. Rectangular samples were compression molded and run on Rheometrics RSA II Solid Analyzer instrument in uniaxial tensile mode from −100 to 60° C. at a 2° C./minute heating rate and at 1 Hz. Storage and loss moduli and tangent delta, which is the ratio of loss modulus to storage modulus, were measured and recorded as a function of temperature. The temperature at which loss modulus has its maximum value is reported as the glass transition temperature

The values “MH” and “ML” used here and throughout the description refer to “maximum torque” and “minimum torque”, respectively. The “MS” value is the Mooney scorch value, the “ML(1+4)” value is the Mooney viscosity value. The error (2σ) in the later measurement is ±0.65 Mooney viscosity units. The values of “T” are cure times in minutes, and “Ts” is scorch time”.

Molecular weight of the PARAPOL™ polybutene processing oil was determined by gel permeation chromatography, and the values of number average molecular weight (Mn) obtained have an error of ±20%. The techniques for determining the molecular weight (Mn and Mw) and molecular weight distribution (MWD) are generally described in U.S. Pat. No. 4,540,753 to Cozewith et al. and references cited therein, and in Verstrate et al., 21 M ACROMOLECULES 3360 (1988). In a typical measurement, a 3-column set is operated at 30° C. The elution solvent used may be stabilized tetrahydrofuran (THF), or 1,2,4-trichlorobenzene (TCB). The columns are calibrated using polystyrene standards of precisely known molecular weights. A correlation of polystyrene retention volume obtained from the standards, to the retention volume of the polymer tested yields the polymer molecular weight. The viscosity of the PARAPOL™ polybutene processing oil was determined as per ASTM D445-97. (See Table 1 values).

Tensile measurements were done at ambient temperature on Instron Series IX Automated Materials Testing System 6.03.08. Micro tensile specimens (dog-bone shaped) width of 0.08 inches (0.20 cm) and a length of 0.2 inches (0.5 cm) length (between two tabs) were used. The thickness of the specimens varied and was measured manually by Mitutoyo Digimatic Indicator connected to the system computer. The specimens were pulled at a crosshead speed of 20 inches/min. (51 cm/min.) and the stress/strain data was recorded. The average stress/strain value of at least three specimens is reported. The error (2σ) in tensile measurements is ±0.47 MPa units.

Permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (×10⁸) units. Other test methods are described in Table 2.

### EXAMPLES

The present invention, while not meant to be limiting by, may be better understood by reference to the following examples (Compositions 1-16, with Composition 1, 7 and 14 being comparative examples) and Tables.

The halogenated rubber component of the present invention is mixed with the other components by first combining the rubber components and mixed in a Banbury™ blender for 30 seconds at about 90° C., at which time ¾ of the carbon black is added. Then, after mixing for several minutes and reaching a temperature of about 110° C., all of the remaining ingredients (processing oils, etc.) except for the curing ingredients (ZnO, MBTS and sulfur) are then added and blended. The mixing is then stopped when the temperature reaches about 140° C., and allowed to cool to room temperature. Finally, the curing ingredients are added in a subsequent mixing step and blended in to form the compositions 1-13 of the present invention.

Compositions 1-4 (Table 3) exemplify the halogenated butyl rubber embodiment of the invention, wherein Composition 1 is a comparative example with no added polybutene processing oil, and Compositions 2 and 3 have 7 phr of the 2500 Mn polybutene processing oil, and Composition 4 has 7 phr of the 1300 Mn polybutene processing oil. When the 2500 Mn polybutene processing oil is used in place of the naphthenic oil CALSOL™ in Composition 2, the air permeability is improved as shown in Table 4, but the brittleness of the composition is not improved. When the 2500 Mn polybutene processing oil is used in place of the STRUKTOL™ aliphatic-naphthenic resin, the brittleness is improved, but not the air permeability. The 1300 Mn polybutene processing oil does not improve either property. These data exemplify the balance that is struck between the air permeability of the compositions and the brittleness.

Compositions 5-13 in Table 4 exemplify the halogenated star-branched butyl rubber embodiment of the invention, wherein Composition 7 is a comparative example of the halogenated star-branched rubber without added polybutene processing oil, while Compositions 8-13 are examples of compositions with the polybutene processing oil. Compositions 5 and 6 are comparative examples of the halogenated butyl rubber embodiment. The data in Tables 7-9 show that the processing and cure properties of the halogenated star-branched butyl rubber Compositions remain largely unchanged by additions of polybutene processing oil, while the air permeability improves. In particular, the Compositions 10-13 shown the largest improvement in air permeability, while the Compositions 8 and 9 show no significant improvement.

The air permeability of the halogenated star-branched butyl polymer composition of the invention is in the range of from 1 to 3×10⁻⁸ cm³-cm/cm²-sec-atm at 65° C. in one embodiment, and from 1.5 to 1.8×10₋₈ cm³-cm/cm²-sec-atm at 65° C. in another embodiment. This amounts to about a 40% decrease in permeability in going from compositions with no polybutene processing oil, to compositions including the 2700 Mn polybutene processing oil. This occurs with little change in the Tg or brittleness values. In one embodiment, the Tg values of the inventive compositions is from −38° C. to −34° C. Thus, these data indicate an improvement in the air permeability for innerliners with addition of polybutene processing oil of an Mn of at least 900, and desirably with addition of polybutene processing oil of an Mn of at least 1300.

Compositions 14-16 exemplify the use of a semi-crystalline copolymer (ethylene-propylene) having a random ethylene content of about 9.3 wt %, wherein the propylene segments constitute the crystalline portion of the polymer, as a secondary rubber present at 20 phr. The 2700 Mn polybutene processing oil is used in Composition 15 and 16, with no paraffinic oil in Composition 15. As can be seen in Table 11, the air permeability of these compositions improves with addition of the polybutene processing oil, especially when used without the paraffinic oil.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 2
Test Methods

| Parameter | Units | Test |
|---|---|---|
| Mooney Viscosity | ML 1 + 8, 125° C., MU | ASTM D 1646 |
| (polymer) | | (modified) |
| Air permeability | Cm³-cm/cm²-sec-atm | See text |
| Brittleness | ° C. | ASTM D 746 |
| Tg (Tan Delta max) | ° C. | See text |
| Green Strength | PSI | ASTM D 412 |
| (100% Modulus) | | |
| Mooney Viscosity | ML1 + 4, 100° C., MU | ASTM D 1646 |
| (compound) | | |
| Mooney Scorch Time | T_{S}5, 125° C., minutes | ASTM D 1646 |
| Oscillating Disk | | ASTM D 2084 |
| Rheometer (ODR) | | |
| @ 160° C., ±3° arc | | |
| ML | deciNewton · meter | |
| MH | deciNewton · meter | |
| T_{S}2 | minute | |
| T₉₀ | minute | |
| Cure rate | daN · m/minute | |
| Physical Properties | | ASTM D 2240 |
| press cured Tc 90 + 2 min | | ASTM D 412 |
| @ 160° C. | | die C |
| Hardness | Shore A | |
| Modulus 100% | MPa | |
| Tensile Strength | MPa | |
| Elongation at Break | % | |
| Hot Air Aging, 72 hrs. | | ASTM D 573 |
| @ 125° C. | | |
| Hardness Change | % | |
| Tensile Change | % | |
| Elongation Change | % | |
| Weight Change | % | |
| Tear Strength | N/mm | ASTM D 624 |
| Die B & Die C | | |

TABLE 3
Various Components in the Compositions

| Component | Brief Description | Commercial Source |
|---|---|---|
| Bromobutyl-2222 | Brominated butyl | ExxonMobil Chemical |
| | rubber, 27-37 Mooney | Company (Houston, |
| | Viscosity | TX) |
| Bromobutyl-2255 | Brominated butyl | ExxonMobil Chemical |
| | rubber, 41-51 Mooney | Company (Houston, |
| | Viscosity | TX) |
| Bromobutyl-6222 | Brominated butyl | ExxonMobil Chemical |
| | rubber with styrene | Company (Houston, |
| | block copolymer | TX) |
| BUDENE ™ 1207 | cis-polybutadiene | Goodyear Chemical |
| | | Company (Akron, OH) |
| CALSOL ™ 810 | Naphthenic Oil | R. E. Carroll, Inc |
| | ASTM Type 103 | (Trenton, NJ) |
| KADOX ™ 930 | High Purity French | Zinc Corp. of America |
| | Process Zinc Oxide | (Monaca, Pa) |
| MAGLITE-K ™ | Magnesium Oxide | C. P. Hall Co. |
| | | (Stow, Ohio) |
| PARAPOL ™ | C₄ raffinate | ExxonMobil Chemical |
| | | Company (Houston, |
| | | TX) |
| Rosin Oil MR 1085A | Rosin Oil | Arizona Chemical |
| | | (Panama City, Fl) |
| SP-1068 | Alkyl Phenol | Schenectady Int. |
| | Formaldehyde Resin | (Schenectady, |
| | | NY) |
| STRUKTOL ™ 40 MS | composition of | Struktol Co. of |
| | aliphatic-aromatic- | America (Stow, |
| | naphthenic resins | Ohio) |
| Zinc Oxide 720-C | Surface Treated | Zinc Corp. of America |
| | French Process | (Monaca, Pa) |
| | Zinc Oxide | |

TABLE 4
Example Compositions of Bromobutyl Rubber with
polybutene processing oil

| Component (phr) | 1 | 2 | 3 | 4 |
|---|---|---|---|---|
| Bromobutyl 2222 | 80 | 80 | 80 | 80 |
| Natural Rubber | 20 | 20 | 20 | 20 |
| Carbon Black N-660 | 60 | 60 | 60 | 60 |
| Stearic acid | 1 | 1 | 1 | 1 |
| CALSOL ™ 810 | 7 | — | 7 | 7 |
| SP-1068 | 4 | 4 | 4 | 4 |
| STRUKTOL ™ 40 MS | 7 | 7 | — | — |
| PARAPOL ™ 2500 | — | 7 | 7 | — |
| PARAPOL ™ 1300 | — | — | — | 7 |
| KADOX ™ 930 | 3 | 3 | 3 | 3 |
| MBTS | 1.25 | 1.25 | 1.25 | 1.25 |
| Sulfur | 0.10 | 0.10 | 0.10 | 0.10 |

TABLE 5
Example Composition Properties of Bromobutyl Rubber with
polybutene processing oil

| Property | 1 | 2 | 3 | 4 |
|---|---|---|---|---|
| Mooney Scorch @ 135° C., | 18.33 | 16.33 | 14.55 | 15.06 |
| T10 (min) | | | | |
| Mooney Viscosity @ 100° C., | 49.2 | 54.3 | 48.9 | 44.1 |
| ML(1 + 4) | | | | |
| Tc50 | 10.37 | 10.25 | 9.36 | 8.56 |
| Tc90 | 18.37 | 18.11 | 15.26 | 14.11 |
| Hardness, Shore A | 48.5 | 50.3 | 52.3 | 45.9 |
| 100% Modulus, MPa | 0.91 | 1.12 | 1.21 | 1.09 |
| 300% Modulus, MPa | 2.73 | 3.54 | 4.96 | 4.27 |
| Tensile strength, MPa | 8.09 | 8.61 | 9.06 | 8.56 |
| Energy to Break | 9.88 | 10.09 | 7.99 | 7.99 |
| Elongation, % | 802 | 763 | 564 | 599 |
| Air Permeability @ 65° C. | 4.61 | 3.24 | 4.47 | 4.77 |
| cm³-cm/cm²-sec-atm × 10⁸ | | | | |
| Green Strength | 45.97 | 54.67 | 48.00 | 38.57 |
| Brittleness ° C. | −45 | −43 | −48 | −46 |

TABLE 6
Example Compositions of Star-branched bromobutyl
rubber with polybutene processing oil

| Component (phr) | 5 | 6 | 7 | 8 | 9 | 10 | 11 | 12 | 13 |
|---|---|---|---|---|---|---|---|---|---|
| Bromobutyl 2222 | 100 | — | — | — | — | — | — | — | — |
| Carbon Black N-660 | 60 | 60 | 60 | 60 | 60 | 60 | 60 | 60 | 60 |
| CALSOL ™ 810 | 8 | 8 | 8 | — | — | — | — | — | — |
| STRUKTOL ™ 40MS | 7 | 7 | 7 | 7 | 7 | 7 | 7 | 7 | 7 |
| SP-1068 | 4 | 4 | 4 | 4 | 4 | 4 | 4 | 4 | 4 |
| Stearic Acid | 2 | 2 | 2 | 2 | 2 | 2 | 2 | 2 | 2 |
| MAGLITE-K ™ | 0.15 | 0.15 | 0.15 | 0.15 | 0.15 | 0.15 | 0.15 | 0.15 | 0.15 |
| Bromobutyl-2255 | — | 100 | — | — | — | — | — | — | — |
| Bromobutyl-6222 | — | — | 100 | 100 | 100 | 100 | 100 | 100 | 100 |
| PARAPOL ™ 450 | — | — | — | 8 | — | — | — | — | — |
| PARAPOL ™ 700 | — | — | — | — | 8 | — | — | — | — |
| PARAPOL ™ 950 | — | — | — | — | — | 8 | — | — | — |
| PARAPOL ™ 1300 | — | — | — | — | — | — | 8 | — | — |
| PARAPOL ™ 2400 | — | — | — | — | — | — | — | 8 | — |
| PARAPOL ™ 2500 | — | — | — | — | — | — | — | — | 8 |
| Zinc Oxide 720-C | 3 | 3 | 3 | 3 | 3 | 3 | 3 | 3 | 3 |
| MBTS | 1.5 | 1.5 | 1.5 | 1.5 | 1.5 | 1.5 | 1.5 | 1.5 | 1.5 |
| Sulfur | 5 | 5 | 5 | 5 | 5 | 5 | 5 | 5 | 5 |

TABLE 7
Example Composition Properties of Star-branched
bromobutyl rubber with polybutene processing oil

| Property | 5 | 6 | 7 | 8 | 9 | 10 | 11 | 12 | 13 |
|---|---|---|---|---|---|---|---|---|---|
| Mooney Scorch, 135° C. (min) | | | | | | | | | |
| T3 | 14.82 | 11.75 | 17.95 | 18.65 | 18.48 | 18.05 | 18.02 | 18.5 | 17.98 |
| T5 | 16.75 | 13.23 | 21.37 | 22.02 | 21.73 | 21.68 | 21.43 | 22.32 | 21.4 |
| T10 | 19.32 | 15.07 | 25.67 | 26.15 | 25.73 | 26.02 | 25.62 | 26.7 | 25.6 |
| Mooney Viscosity, 100° C. | 58.0 | 69.4 | 53.8 | 54.3 | 57.2 | 56.7 | 56.8 | 57.2 | 57.4 |
| (1 + 4) @ ODR (min) | | | | | | | | | |
| ODR, ARC 3°, 160° C. | | | | | | | | | |
| MH-ML | 24.89 | 27.62 | 23.86 | 18.12 | 19.05 | 19.95 | 20.38 | 22.08 | 22.09 |
| ML | 9.98 | 13.91 | 7.69 | 8.08 | 8.56 | 8.50 | 8.64 | 8.92 | 9.16 |
| MH | 34.87 | 41.53 | 31.55 | 26.20 | 27.61 | 28.45 | 29.02 | 31 | 31.25 |
| Ts2 | 3.99 | 3.50 | 4.72 | 4.92 | 4.91 | 4.75 | 4.8 | 4.84 | 4.74 |
| Tc25 | 5.86 | 5.24 | 6.96 | 6.51 | 6.61 | 6.61 | 6.75 | 7.13 | 6.91 |
| Tc50 | 9.07 | 7.93 | 10.33 | 9.30 | 9.57 | 9.67 | 9.91 | 10.64 | 10.24 |
| Tc90 | 27.49 | 29.50 | 25.43 | 15.23 | 16.64 | 17.39 | 18.58 | 22.05 | 21.47 |
| Rate | 2.46 | 3.29 | 1.90 | 1.73 | 1.74 | 1.75 | 1.72 | 1.65 | 1.74 |

TABLE 8
Example Composition Properties of Star-branched
bromobutyl rubber with polybutene processing oil

| Property | 5 | 6 | 7 | 8 | 9 | 10 | 11 | 12 | 13 |
|---|---|---|---|---|---|---|---|---|---|
| Shore A Hardness, Non-aged | 56 | 56 | 60 | 58 | 60 | 61 | 61 | 61 | 62 |
| Shore A Hardness, Aged 72 Hrs. @ | 60 | 60 | 64 | 61 | 59 | 59 | 58 | 58 | 58 |
| 125° C. | | | | | | | | | |
| Stress/Strain, Non-aged @ 25° C., | | | | | | | | | |
| Cure T90 + 2 @ 160 C | | | | | | | | | |
| 100% Modulus, MPa | 1.28 | 1.57 | 1.62 | 1.42 | 1.63 | 1.59 | 1.54 | 1.66 | 1.69 |
| 200% Modulus, MPa | 2.58 | 3.40 | 3.15 | 2.81 | 3.15 | 3.02 | 2.93 | 3.20 | 3.37 |
| 300% Modulus, MPa | 4.17 | 5.37 | 4.80 | 4.39 | 4.82 | 4.63 | 4.57 | 4.90 | 5.14 |
| Tensile, MPa | 9.79 | 11.21 | 8.86 | 8.80 | 8.91 | 8.90 | 8.82 | 9.15 | 8.88 |
| % Elongation | 715 | 697 | 626 | 639 | 616 | 643 | 637 | 610 | 620 |
| Stress/Strain, Aged 72 Hrs @ 125° C. | | | | | | | | | |
| Cure T90 + 2 @ 160° C. | | | | | | | | | |
| 100% Modulus, MPa | 2.79 | 3.06 | 3.22 | 2.83 | 2.70 | 2.63 | 2.48 | 2.45 | 2.64 |
| 200% Modulus, MPa | 5.56 | 6.13 | 5.80 | 5.32 | 5.08 | 4.84 | 4.75 | 4.74 | 5.11 |
| 300% Modulus, MPa | 7.60 | 8.02 | 7.47 | 7.07 | 6.72 | 6.46 | 6.51 | 6.52 | 6.82 |
| Tensile, MPa | 9.57 | 9.46 | 8.38 | 8.49 | 8.53 | 8.15 | 8.14 | 8.33 | 8.29 |
| % Elongation | 520 | 482 | 414 | 476 | 491 | 496 | 464 | 474 | 462 |
| Adhesion @ 25° C. | 33.51 | 33.73 | 23.34 | 21.57 | 24.44 | 24.49 | 23.59 | 25.06 | 18.87 |
| To Natural Rubber Carcass | | | | | | | | | |
| Tear Resistance, N/mm | | | | | | | | | |
| Green Strength, Modulus @ 100% PSI | 47.27 | 56.55 | 46.55 | 45.39 | 51.19 | 49.88 | 49.74 | 50.32 | 50.32 |
| Time to Decay 75% from strain end | 4.20 | 8.47 | 1.78 | 1.75 | 1.48 | 1.44 | 1.42 | 0.98 | 1.32 |
| point (min) | | | | | | | | | |

TABLE 9
Example Composition Properties of Star-branched
bromobutyl rubber with polybutene processing oil

| Properties | 5 | 6 | 7 | 8 | 9 | 10 | 11 | 12 | 13 |
|---|---|---|---|---|---|---|---|---|---|
| Non-aged Die-B Tear | | | | | | | | | |
| Tear Resistance (N/mm) | 57.02 | 59.63 | 52.68 | 52.77 | 52.92 | 53.31 | 52.98 | 55.28 | 54.63 |
| Aged Die-B Tear | | | | | | | | | |
| Tear Resistance (N/mm) | 58.60 | 59.19 | 55.54 | 56.26 | 53.76 | 51.53 | 53.87 | 55.98 | 55.13 |
| Non-aged Die-C Tear | | | | | | | | | |
| Tear Resistance (N/mm) | 37.37 | 37.48 | 35.19 | 35.66 | 34.63 | 35.41 | 34.96 | 36.20 | 35.59 |
| Aged Die-C Tear | | | | | | | | | |
| Tear Resistance (N/mm) | 32.25 | 30.87 | 30.72 | 29.62 | 30.47 | 30.98 | 30.70 | 30.28 | 31.90 |
| Air Permeability @ | 3.37 | 3.13 | 2.69 | 2.90 | 2.63 | 2.42 | 2.02 | 1.61 | 1.86 |
| 65° C., | | | | | | | | | |
| cm³-cm/cm²-sec-atm | | | | | | | | | |
| (× 10⁸) | | | | | | | | | |
| Tg (Tan Delta max), ° C. | −37.9 | −37.0 | −38.0 | −37.9 | −36.1 | −36.0 | −36.2 | −35.9 | −35.0 |

TABLE 10
Example Compositions of Semi-Crystalline Polymers
and Star-branched bromobutyl rubber
with polybutene processing oil

| Component (phr) | 14 | 15 | 16 |
|---|---|---|---|
| Bromobutyl 6222 | 80 | 80 | 80 |
| Semi-crystalline copolymer | 20 | 20 | 20 |
| PARAPOL ™ 2500 | — | 5 | 5 |
| Paraffinic oil | 5 | — | 5 |
| STRUKTOL ™ 40 MS | 5 | 5 | 5 |
| N660 carbon black | 60 | 60 | 60 |
| SP 1068 | 4 | 4 | 4 |
| HST (stearic acid) | 2 | 2 | 2 |
| MgO, Maglite K | 0.15 | 0.15 | 0.15 |
| ZnO | 3 | 3 | 3 |
| Sulfur | 0.5 | 0.5 | 0.5 |
| MBTS | 1.5 | 1.5 | 1.5 |

TABLE 11
Example Composition Properties of Semi-Crystalline
Polymers and Star-branched bromobutyl rubber

| | | | |
|---|---|---|---|
| Property | 14 | 15 | 16 |

ODR 160° C., 60 min, 3° Arc

| | | | |
|---|---|---|---|
| Ts2 | 4.48 | 4.53 | 4.6 |
| T90 | 33.39 | 27.35 | 28.04 |
| Die C, 50° C., Tear Resistance | 23.7 | 26.3 | 20.7 |

Tensile, Non-Aging, 25° C.

| | | | |
|---|---|---|---|
| 100% Mod., MPa | 2.076 | 2.040 | 1.742 |
| 300% Mod., MPa | 5.942 | 5.609 | 4.972 |
| Stress at Break, MPa | 9.082 | 9.275 | 8.787 |
| % Strain at Break, % | 680 | 730 | 705 |

Shore A Hardness

| | | | |
|---|---|---|---|
| Non-Aging | 65.5 | 69.1 | 62.1 |
| Aging | 66.3 | 68.1 | 61.1 |
| Air Permeability @ 35° C., cm³-cm/cm²-sec-atm | 1.32 | 1.19 | 1.32 |
| (× 10⁸) | | | |
| Air Permeability @ 65° C., cm³-cm/cm²-sec-atm | 5.66 | 4.87 | 5.27 |
| (× 10⁸) | | | |

We claim:

1. An elastomeric composition comprising at least one halogenated rubber, at least one filler, and a polybutene processing oil having a number average molecular weight of at least 700 with the provision that no semi-crystalline polymer is present in the composition.

2. The composition of claim 1, wherein the halogenated rubber is a halogenated butyl rubber.

3. The composition of claim 1, wherein the halogenated rubber is a halogenated star-branched butyl rubber comprising polydiene derived units, C₄ to C₆ isoolefin derived units, and conjugated diene derived units.

4. The composition of claim 3, wherein the polydiene is selected from polybutadiene, styrene, polyisoprene, polypiperylene, natural rubber, styrene-butadiene rubber, ethylene-propylene diene rubber, styrene-butadiene-styrene and styrene-isoprene-styrene block copolymers, and mixtures thereof.

5. The composition of claim 2, wherein the halogenated butyl rubber is a polymer of isobutylene derived units and isoprene derived units.

6. The composition of claim 1, wherein the polybutene processing oil has a molecular weight of at least 900.

7. The composition of claim 1, wherein the polybutene processing oil has a molecular weight of from 900 to 6000.

8. The composition of claim 1, wherein the polybutene processing oil is present in the composition from 2 to 30 phr.

9. The composition of claim 1, wherein the halogenated rubber component is present in the composition from 50 to 100 phr.

10. The composition of claim 1, further comprising a secondary rubber component selected from natural rubbers, polyisoprene rubber, styrene butadiene rubber, polybutadiene rubber, isoprene butadiene rubber, styrene isoprene butadiene rubber, ethylene-propylene rubber, semi-crystalline copolymer, and mixtures thereof.

11. The composition of claim 3, wherein the halogenated rubber is a composition of a halogenated butyl rubber and a halogenated star-branched butyl rubber.

12. The composition of claim 1, wherein viscosity of the polybutene processing oil is greater than 35 cSt at 100° C.

13. A tire innerliner formed from the composition of claim 1.

14. An elastomeric composition comprising at least one halogenated star-branched butyl rubber, at least one filler, and polybutene processing oil having a molecular weight of at least 700.

15. The composition of claim 14, wherein the halogenated star-branched butyl rubber comprises polydiene derived units, C₄ to C₆ isoolefin derived units, and conjugated diene derived units.

16. The composition of claim 15, wherein the polydiene is selected from polybutadiene, styrene, polyisoprene, polypiperylene, natural rubber, styrene-butadiene rubber, ethylene-propylene diene rubber, styrene-butadiene-styrene and styrene-isoprene-styrene block copolymers, and mixtures thereof.

17. The composition of claim 14, wherein the polybutene processing oil has a molecular weight of less than 8000.

18. Thc composition of claim 14, wherein the polybutene processing oil has a molecular weight of from 700 to 8000.

19. The composition of claim 14, wherein the polybutene processing oil is present in the composition from 2 to 30 phr.

20. The composition of claim 14, wherein the halogenated star-branched butyl rubber is present in the composition from 50 to 100 phr.

21. The composition of claim 14, further comprising a secondary rubber component selected from natural rubbers, polyisoprene rubber, styrene butadiene rubber, polybutadiene rubber, isoprene butadiene rubber, styrene isoprene butadiene rubber, ethylene-propylene rubber, semi-crystalline copolymer, and mixtures thereof.

22. The composition of claim 14, also comprising halogenated butyl rubber.

23. The composition of claim 14, wherein the filler is carbon black.

24. The composition of claim 23, wherein the carbon black is present from 10 to 150 phr.

25. The composition of claim 14, wherein the air permeability of the cured composition is from 1×10⁻⁸ to 3×10⁻⁸ cm³-cm/cm²-sec-atm at 65° C.

26. A tire innerliner formed from the composition of claim 14.

27. An air barrier formed by combining at least one halogenated rubber component, at least one filler, a polybutene processing oil having a number average molecular weight at least 700, a viscosity in the range of 10 to 6000 cSt at 100° C., and at least one cure agent; and curing the combined components.

28. The air barrier of claim 27, wherein the halogenated rubber component is a halogenated butyl rubber.

29. The air barrier of claim 28, wherein the halogenated rubber component is a halogenated star-branched butyl rubber comprising polydiene derived units, C₄ to C₆ isoolefin derived units, and conjugated diene derived units.

30. The air barrier of claim 29, wherein the polydiene is selected from polybutadiene, styrene, polyisoprene, polypiperylene, natural rubber, styrene-butadiene rubber, ethylene-propylene diene rubber, styrene-butadiene-styrene and styrene-isoprene-styrene block copolymers, and mixtures thereof.

31. The air barrier of claim 28, wherein the halogenated butyl rubber is a polymer of isobutylene derived units and isoprene derived units.

32. The air barrier of claim 27, wherein the polybutene processing oil has a molecular weight of at least 900.

33. The air barrier of claim 27, wherein the polybutene processing oil has a molecular weight of from 400 to 8000.

34. The air barrier of claim 27, wherein the polybutene processing oil is present in the composition from 2 to 30 phr.

35. The air barrier of claim 27, wherein the halogenated rubber component is present in the composition from 50 to 100 phr.

36. The air barrier of claim 27, further comprising a secondary rubber component selected from natural rubbers, polyisoprene rubber, styrene butadiene rubber, polybutadiene rubber, isoprene butadiene rubber, styrene isoprene butadiene rubber, ethylene-propylene rubber, semi-crystalline copolymer, and mixtures thereof.

37. The air barrier of claim 27, wherein the halogenated rubber component is a composition of a halogenated butyl rubber and a halogenated star-branched butyl rubber.

38. The air barrier of claim 27, wherein the filler is carbon black and is present from 10 to 150 phr.

39. The air barrier of claim 27, wherein the air permeability is from 1×10⁻⁸ to 3×10⁻⁸ cm³-cm/cm²-sec-atm at 65° C.

40. The air barrier of claim 27, wherein viscosity of the polybutene processing oil is greater than 35 cSt at 100° C.

41. An elastomeric composition comprising a halogenated rubber, a filler, and polybutene processing oil having a number average molecular weight of at least 900 and a viscosity of greater than 100 cSt at 100° C.

42. The composition of claim 41, wherein the filler is carbon black.

43. The composition of claim 41, wherein the halogenated rubber is a halogenated butyl rubber.

44. The composition of claim 41, wherein the halogenated rubber is a halogenated star-branched butyl rubber comprising polydiene derived units, C₄ to C₆ isoolefin derived units, and conjugated diene derived units.

45. The composition of claim 44, wherein the polydiene is selected from polybutadiene, styrene, polyisoprene, polypiperylene, natural rubber, styrene-butadiene rubber, ethylene-propylene diene rubber, styrene-butadiene-styrene and styrene-isoprene-styrene block copolymers, and mixtures thereof.

46. The composition of claim 43, wherein the halogenated butyl rubber is a polymer of isobutylene derived units and isoprene derived units.

47. The composition of claim 41, further comprising a secondary rubber component selected from natural rubbers, polyisoprene rubber, styrene butadiene rubber, polybutadiene rubber, isoprene butadiene rubber, styrene isoprene butadiene rubber, ethylene-propylene rubber, semi-crystalline copolymer, and mixtures thereof.

48. The composition of claim 41, wherein the polybutene processing oil is present in the composition from 2 to 30 phr.

49. The composition of claim 41, wherein the halogenated rubber component is present in the composition from 50 to 100 phr.

50. A tire innerliner formed from the composition of claim 41.

51. An elastomeric composition comprising at least one halogenated star-branched butyl rubber comprising polydiene derived units, C₄ to C₆ isoolefin derived units, and conjugated diene derived units, carbon black, and polybutene processing oil having a molecular weight of at least 900 and a viscosity of greater than 35 cSt at 100° C.

52. The composition of claim 51, wherein the carbon black is N660 carbon black.

53. The composition of claim 51, wherein the polydiene is selected from polybutadiene, styrene, polyisoprene, polypiperylene, natural rubber, styrene-butadiene rubber, ethylene-propylene diene rubber, styrene-butadiene-styrene and styrene-isoprene-styrene block copolymers, and mixtures thereof.

54. The composition of claim 51, further comprising a halogenated butyl rubber that is a polymer of isobutylene derived units and isoprene derived units.

55. The composition of claim 51, wherein the polybutene processing oil is present in the composition from 2 to 30 phr.

56. The composition of claim 51, wherein the halogenated rubber component is present in the composition from 50 to 100 phr.

57. The composition of claim 51, wherein the polybutene processing oil is a copolymer of isobutylene derived units and 1-butene derived units.

58. The composition of claim 51, further comprising a semi-crystalline copolymer.

59. A tire innerliner formed from the composition of claim 51.

60. An elastomeric composition comprising at least one elastomer, at least one filler, and polybutene processing oil having a number average molecular weight of from 700 to 10,000.

61. The composition of claim 60, wherein the polybutene has a viscosity of from 10 to 6000 cSt at 100° C.

62. The composition of claim 60, wherein the polybutene is present from 2 to 30 phr.

63. The composition of claim 60, wherein the elastomer is halogenated butyl rubber or halogenated star-branched butyl rubber.

64. The composition of claim 60, wherein the elastomer is selected from brominated butyl rubber, chlorinated butyl rubber, halogenated isoprene and halogenated isobutylene copolymers, polychloroprene, star-branched polyisobutylene rubber, star-branched brominated butyl, and the like halomethylated aromatic interpolymers, and mixtures thereof.
